(19) United States
(12) Patent Application Publication
(10) Pub. No.: US 2026/0010929 A1
(43) Pub. Date: Jan. 8, 2026

(54) SYSTEM AND METHOD OF AUTOMATED ASSESSMENT OF OBJECTS USING MACHINE LEARNING MODEL AND DISTRIBUTED LEDGER

(71) Applicant: Quotidian Engineering and Development Corp., Lewes, DE (US)

(72) Inventors: Leigh R. Keno, Mohawk, NY (US); Joseph R. McCoy, Frankfort, NY (US); Christopher M. Smolen, Oneida, NY (US); Yuchao Zhou, Monero Valley, CA (US)

(21) Appl. No.: 19/259,463

(22) Filed: Jul. 3, 2025

Related U.S. Application Data
(60) Provisional application No. 63/667,531, filed on Jul. 3, 2024.

(51) Int. Cl. G06Q 30/02; G06V 10/776; G06V 10/82; G06V 20/00; G06V 40/50

(52) U.S. Cl. CPC G06Q 30/0278; G06V 10/776; G06V 10/82; G06V 20/95; G06V 40/50

(57) ABSTRACT

Embodiments of the disclosure provide a system and method of automated assessment of objections using a machine learning model. A method of the disclosure includes applying an image recognition model to an image of an object of interest to identify at least one reference feature of the object of interest from the image. The reference feature of the object of interest is analyzed via a machine learning model trained on a curated database of identifiable features. The curated database includes a listing of known art or collectibles cross-referenced to appraised values for each known art or collectible in the listing. The method includes calculating an appraised value for the object based on the analyzing and generating an audit report for the object of interest. The audit report includes a record of at least one item in the curated database used by the machine learning model to calculate the appraised value.

### TECHNICAL FIELD

The technology relates to assessing objects such as works of art.

### BACKGROUND

Valuable physical objects, such as art and antiquities, are often faked, forged or stolen. Furthermore, owners of old, historic and potentially valuable objects are often interested in authentication and appraisal of worth for tax or insurance purposes.

Provenance of an object is a chronology of the sequences of the object's formal ownership, custody and places of storage. For museums and the art trade, in addition to helping establish the authorship and authenticity of an object, provenance has become increasingly important in helping establish the moral and legal validity of a chain of custody.

In the absence of adequate documentation, establishing provenance may require comparative techniques, expert opinions, and/or scientific tests. However, the human-implemented techniques can be subjective and not consistent from evaluator to evaluator. The scientific tests are expensive and do not provide all information required. Thus, there is a need for improved technological systems and methods that facilitate recording the provenance of objects and particularly, for systems and methods that facilitate verifying provenance without the effort and expense of comparative techniques, expert opinions, and/or scientific tests.

### SUMMARY

The illustrative aspects of the present disclosure are designed to solve the problems herein described and/or other problems not discussed.

Aspects of the present disclosure relate to automated assessment of an object verifying the provenance of an object. Issues associated with conventional technologies are addressed by the subject matter of the independent claims included in this document. Additional aspects are included in the dependent claims.

In one aspect, the present disclosure provides a method including: applying an image recognition model to an image of an object of interest to identify at least one reference feature of the object of interest from the image; analyzing the at least one reference feature of the object of interest via a machine learning model trained on a curated database of identifiable features, the curated database including a listing of known art or collectibles cross-referenced to appraised values for each known art or collectible in the listing; calculating an appraised value for the object based on the analyzing; and generating an audit report for the object of interest, wherein the audit report includes a record of at least one item in the curated database used by the machine learning model to calculate the appraised value.

Further aspects of the disclosure provide a system including: a processor; and a memory having programming instructions configured to cause the processor to perform an appraisal by: applying an image recognition model to an image of an object of interest to identify at least one reference feature of the object of interest from the image; analyzing the at least one reference feature of the object of interest via a machine learning model trained on a curated database of identifiable features, the curated database including a listing of known art or collectibles cross-referenced to appraised values for each known art or collectible in the listing; calculating an appraised value for the object based on the analyzing; and generating an audit report for the object of interest, wherein the audit report includes a record of at least one item in the curated database used by the machine learning model to calculate the appraised value.

Additional aspects of the disclosure include a program product including a computer readable storage medium with program code for causing a computer system to perform actions including: applying an image recognition model to an image of an object of interest to identify at least one reference feature of the object of interest from the image; analyzing the at least one reference feature of the object of interest via a machine learning model trained on a curated database of identifiable features, the curated database including a listing of known art or collectibles cross-referenced to appraised values for each known art or collectible in the listing; calculating an appraised value for the object based on the analyzing; and generating an audit report for the object of interest, wherein the audit report includes a record of at least one item in the curated database.

Implementations of the disclosure may include one or more of the following optional features. In some examples, the instructions are further configured to cause the processor to provide the certifiable appraisal by recording the audit report on a digital ledger. The digital ledger may be a distributed ledger having blocks that are linked together via cryptographic hashes and the instructions that cause the processor to provide the certifiable appraisal by recording the audit report may include instructions that cause the processor to provide the certifiable appraisal by adding one or more blocks to the distributed ledger. In some examples, the instructions that cause the processor to provide the certifiable appraisal by training the machine learning model based on the curated database include instructions that cause the processor to provide the certifiable appraisal by training a visual large-language model. In some examples, the instructions that cause the processor to provide the certifiable appraisal by receiving the one or more images of the object include instructions that cause the processor to provide the certifiable appraisal by receiving the one or more images from a mobile device. The instructions that cause the processor to provide the certifiable appraisal by providing the audit report may include instructions that cause the processor to provide the certifiable appraisal by providing output from the machine learning model describing the basis of the appraised value.

### BRIEF DESCRIPTION OF THE DRAWINGS

Other aspects, advantages and novel features of the disclosure will become more apparent from the following detailed description of the disclosure when considered in conjunction with the accompanying drawings which are incorporated into this document and form a part of the disclosure, wherein:

FIG. 1 shows a schematic view of components for implementing systems and methods for automated assessment of objects according to the disclosure.

FIG. 2 shows a schematic view of an example system architecture for implementing methods and systems of the disclosure.

FIG. 3 shows an illustrative computer system environment for implementing methods according to the disclosure.

FIG. 4. provides an illustrative diagram of a machine learning network for implementing systems and methods according to the disclosure.

FIG. 5 provides an illustrative flow diagram illustrating examples of implementing methods in embodiments of the disclosure.

### DETAILED DESCRIPTION

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments disclosed herein were chosen and described to best explain the principles of the disclosure and the practical application, and to enable others of ordinary skill in the art to understand the disclosure for various embodiments with various modifications as are suited to the particular use contemplated.

This document describes system, apparatus, device, and/or method embodiments, and/or combinations and sub-combinations of any of the above, for verifying the provenance of an object. While preferred embodiments of the disclosure are disclosed in the attached materials, many other implementations will occur to one of ordinary skill in the art and are all within the scope of the disclosure. Each of the various embodiments described may be combined with other described embodiments in order to provide multiple features. Furthermore, while the attached materials describe a number of separate embodiments of the apparatus and method of the present disclosure, what has been described is merely illustrative of the application of the principles of the present disclosure. Other arrangements, methods, modifications, and substitutions by one of ordinary skill in the art are therefore also considered to be within the scope of the present invention.

In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other and are not necessarily “superior” and “inferior.” Generally, similar spatial references of different aspects or components indicate similar spatial orientation and/or positioning, i.e., that each “first end” is situated on or directed towards the same end of the device.

Some embodiments will now be described with reference to the figures. Like elements in the various figures may be referenced with like numbers for consistency. In the following description, numerous details are set forth to provide an understanding of various embodiments and/or features.

Embodiments of the disclosure provide a system and method of automated assessment of objects using a machine learning model. A method of the disclosure includes applying an image recognition model to an image of an object of interest to identify at least one reference feature of the object of interest from the image. The reference feature of the object of interest is analyzed via a machine learning model trained on a curated database of identifiable features. The curated database includes a listing of known art or collectibles cross-referenced to appraised values for each known art object or collectible object in the listing. The method includes calculating an appraised value for the object based on the analyzing and generating an audit report for the object of interest. The audit report includes a record of at least one item in the curated database used by the machine learning model to calculate the appraised value.

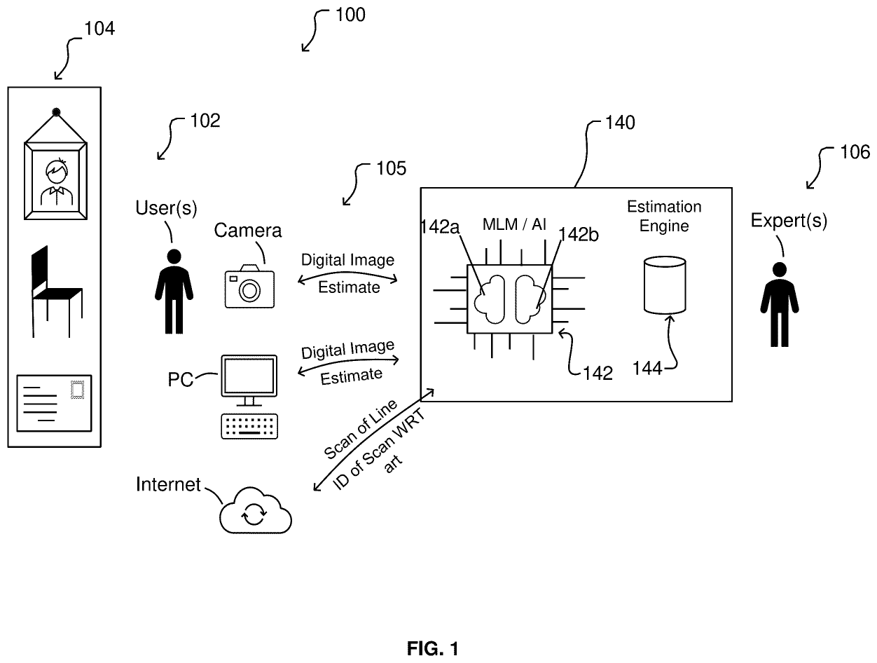

FIG. 1 shows a schematic depiction of an environment 100 for implementing systems and methods to evaluate (e.g., by economic appraisal) an object of interest (simply “object” hereafter) 104. Object 104 may be an artistic work, such as a painting, sculpture, photograph, etc. The object 104 additionally or alternatively may be a collectible item (“collectible”) such as an antique and/or valuable object, such as a vase, a piece of furniture, glassware, a car, or the like. Further examples of collectible items may include a trading card, stamp, coin, book, print, toy, sports memorabilia, and so forth. In some cases, object 104 may fall into more than one of these categories. In still further implementations, object 104 may be a wholly physical asset, a wholly digital aspect, and/or may include physical components in addition to digital components. In various embodiments, the methods and systems described herein may implement a classification, an identification, and/or an estimation of value related to object 104.

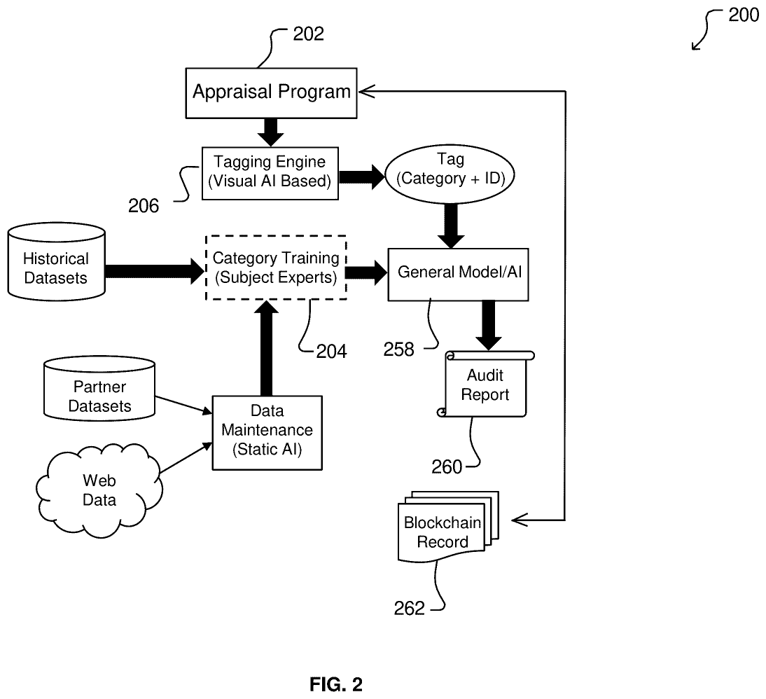

In embodiments of environment 100, one or more users 102 may obtain or otherwise create one or more images 105 of object 104. Images 105 may be created or obtained via any currently known or later developed image capture solution, and examples of such solutions are shown in FIG. 1 and discussed herein. The term “image” as used herein may be inclusive of static images, brief animations, video files with or without audio, and/or other visual records including object(s) 104 therein. User 102 may provide image(s) 105 to a computing device 140 having tools to implement an appraisal and/or other evaluation of object(s) 104, as discussed herein. The providing of image(s) 105 to computing device 140 may include transmission via any conceivable communications network, including local and remote data couplings, e.g., wired and/or wireless data communications networks. In some examples, user(s) 102 may create or provide image 105 using a standalone camera, the camera of a smartphone, tablet, or other electronic device capable of acquiring digital images 105, and/or other solutions. In further examples, user 102 may alternatively or additionally obtain image 105 from an Internet source and/or from another person. Regardless of how image(s) 105 become present in environment 100, user(s) 102 may provide image(s) 105 to computing device 140 having various components therein for implementing desired appraisals and/or evaluations. Thereafter, computing device 140 returns an audit report 260 (FIG. 2) based on image(s) 105. In some embodiments, the audit report 260 is also formally verified by one or more experts 106 before computing device 140 returns audit report 260 to user(s) 102.

Computing device 140 may include an artificial intelligence/machine learning model (“MLM”) 142 and an estimation engine 144. In some examples, MLM 142 includes two or more separate artificial intelligence and/or machine learning models, which collectively define MLM 142. For example, MLM 142 of computing device 140 may include additional machine learning models in the form of one or more image-recognition models 142a and one or more appraisal models 142b. Computing device 140 may apply an image-recognition model 142a to image(s) 105 received from user 102. Image-recognition model 142a may be configured to identify and/or classify object(s) 104 based on images 105 of object(s) 104. Furthermore, image-recognition model 142a may be configured to recognize particular aspects of object(s) 104 based on image(s) 105. For example, image-recognition model 142a may be configured to detect surface patterns, spatial relationships of object 104 and/or components of object 104, and so forth. In one example, the image-recognition model 142a is a convolutional neural network configured to recognize particular types of objects 104. In some examples, image-recognition model 142a includes multiple additional models 142a, each model 142a configured to identify particular types of objects 104. For example, image-recognition model 142a may be configured to recognize paintings, a second image-recognition model 142a may be configured to recognize collectible coins, and so forth. Computing device 140 may apply each of the various image-recognition models 142a to image(s) 105 to identify the object(s) 104 depicted therein. For example, image recognition model(s) 142a may be configured to indicate a likelihood or probability of a successful match. Computing device 140 may further include logic, program code, look up tables (LUTs), etc., operable to choose the identification that is associated with the highest likelihood of a successful match.

In some examples, computing device 140 applies MLM(s) 142 to each of several images 105 of object(s) 104. Computing device 140 may then combine the outputs of the models 142a to generate audit report(s) 260 of object(s) 105. For example, computing device 140 may select the outputs associated with the highest likelihood of a successful match. Alternatively (or in addition), computing device 140 may perform a mathematical function on the outputs, such as averaging the outputs of each model before selecting the highest likelihood of a successful match. MLM(s) 142 may be further refined over time for increased accuracy, e.g., with additional images 105 of object(s) 104.

In the case where object(s) 104, or aspects of object(s) 104, is/are identifiable, computing device 140 may implement one or more additional AI/MLMs 142 on object(s) 104. For example, MLM 142 may include an appraisal model 142b trained using a curated database comprising items of art and/or collectibles and their associated appraised value. In some cases, one or more experts 106 may carefully select representative objects 104 and reliable sources of valuation for the objects 104. Once the database has been compiled, appraisal model 142b may be trained based on the database. After training, appraisal model 142b and/or computing device 140 may be able to generate audit report(s) 260 of additional objects 104 that were not included in the original curated database. As in the case of image-recognition model 142a, appraisal model 142b may be further refined over time using additional items of art and/or collectibles (and their associated appraised value) as additional training data.

Image-recognition model 142a and/or the appraisal model 142b may be generative Artificial Intelligence (AI) models, such as large-language models (LLMs). That is, MLM(s) 142 may be capable of producing text describing the recognized features of object(s) 104 (in the case of the image-recognition model 142a) or text describing the features, condition, or other aspects of object(s) 104 (in the case of the appraisal model 142b) that also serve as a basis for its audit report 260.

In some examples, computing device 140 generates audit report 260 of the appraisal process, e.g., to verify that a particular approval process was followed, and/or document the basis for the appraisal (including, e.g., initial data, image(s) 105, decision methods, names of expert(s) 106 consulted, etc.). According to one such example, the generated audit report 260 may include the initial submission of image(s) 105 by the user 102 and/or the result of a hash function applied to the image(s) 105. Audit report 260 may also include outputs from MLM(s) 142. For example, audit report 260 may include features of object(s) 104 detected by image recognition model 142a. In embodiments where image recognition model 142a generates text output, the record may include the text output. Similarly, audit report 260 may include outputs from the appraisal model 142b, including text output by the model 142b. The text may include a description of the condition of object(s) 104, and/or other salient characteristics that affect audit report 260 or describe the basis for audit report 260. Audit report 260 may also include the results of an additional formal appraisal, e.g., performed by an expert 106 in response to appraisal(s) generated via computing device 140. Audit report 260 may include the credentials of expert(s) 106, including the case where expert(s) 106 are curators and/or administrators of one or more appraisal database(s). Audit report 260 may also include the curated database(s) and/or the model(s) (e.g., 142a, 142b). That is, the record may include an auditable list of the elements used by computing device 140 to produce audit report 260.

In some embodiments, the audit report 260 is provided and/or stored as data (e.g., in digital form). Where applicable, audit report 260 may include or may be included within a distributed digital ledger, such as a blockchain. That is, some or all of the elements used by computing device 140 to produce audit report 260 may be recorded on a blockchain along with audit report 260 itself. In some examples, e.g., when the item is particularly large, computing device 140 may record the result of a hash function applied to the element rather than (or even, in addition to) recording object 104 itself. In this way, the blockchain maintains an immutable record of the elements that form the basis of audit report 260 as well as outputs that form the basis for audit report 260.

FIG. 2 shows a schematic diagram of an appraisal process 200 configured to be implemented via an appraisal program 202 (e.g., a phone-based application). Note that process 200 additionally or alternatively may be performed using any suitable implementation of computing device 140, including any handheld/portable computing devices, such as phones and tablets, or any desktop computing systems. Block 204 indicates processes for obtaining and/or curating training data. Such data may include historical datasets, e.g., of objects and their valuation. The data may include databases curated by third parties or data accessible via the Internet. In some examples, subject matter experts curate the data to include specific sources selected as being reliable and/or authenticated caches of data. In some examples, image(s) 105 (FIG. 1) of object(s) 104 (FIG. 1) is/are acquired, e.g. by a camera of a phone/mobile device. At block 206, appraisal process 200 includes applying a tagging engine, such as a visual large-language model (VLLM) to the image(s) 105 provided by appraisal program 202. In some examples, the tagging engine categorizes image(s) 105. That is, the tagging engine may determine the type of object (e.g., type of collectible, type of art, type of antique, etc.). In some examples, the tagging engine also produces a unique identifier to associate image(s) 105 with one or more objects 104. At step 258, the method includes applying one or more AI/machine learning models 142 (FIG. 1) to the image (or to features of image(s) 105) to produce audit report 260 (as described above). In some examples, audit report 260 includes a dollar value for the object 104 as well as outputs of the models 142 and/or other information that forms the basis of audit report 260. The record of audit report 260 may also be stored on a distributed digital ledger, e.g., as a blockchain record 262.

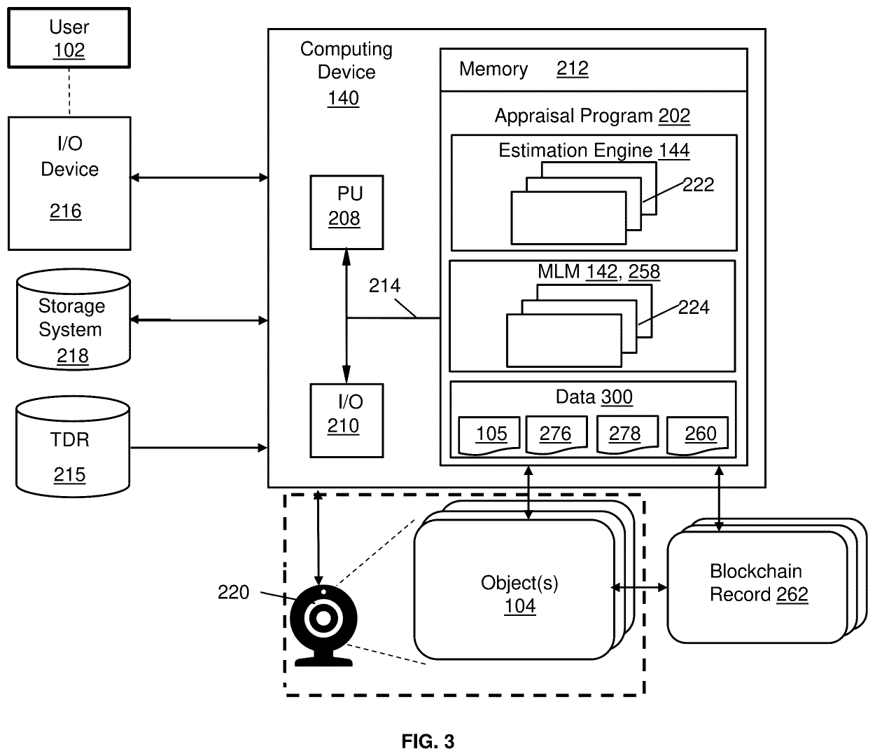

Turning to FIG. 3, embodiments of the disclosure may be implemented using a computing device 140. Computing device 140 may be in communication with one or more image sensors (simply “sensor” hereafter) 220, structurally integrated into sensor(s) 220 and/or other components described herein (e.g., various devices in communication with sensor(s) 220), and/or may be an independent component connected to one or more devices within a team of sensor(s) 220 operating within an environment. Each sensor 220 may be, or may be included within, e.g., a camera, phone, table, and/or other currently known or later developed hardware operable to capture image(s) 105 for analysis. One sensor 220 is shown in FIG. 3 but any number of sensors 220 may be used. Computing device 140 may include a processor unit (PU) 208, an input/output (I/O) interface 210, a memory 212, and a bus 214. Further, computing device 140 is shown in communication with an external I/O device 216, a storage system 218, and a training data repository (TDR) 215. External I/O device 216 may be embodied as any component for allowing user interaction with computing device 140. Memory 212 may include appraisal program 202. Appraisal program 202 may be wholly or partially within memory 212 of computing device 140 and/or other storage system/components herein. In some implementations, computing device 140 may be included within one or more sensors 220, e.g., where sensor 220 refers to a tablet, smartphone, etc.

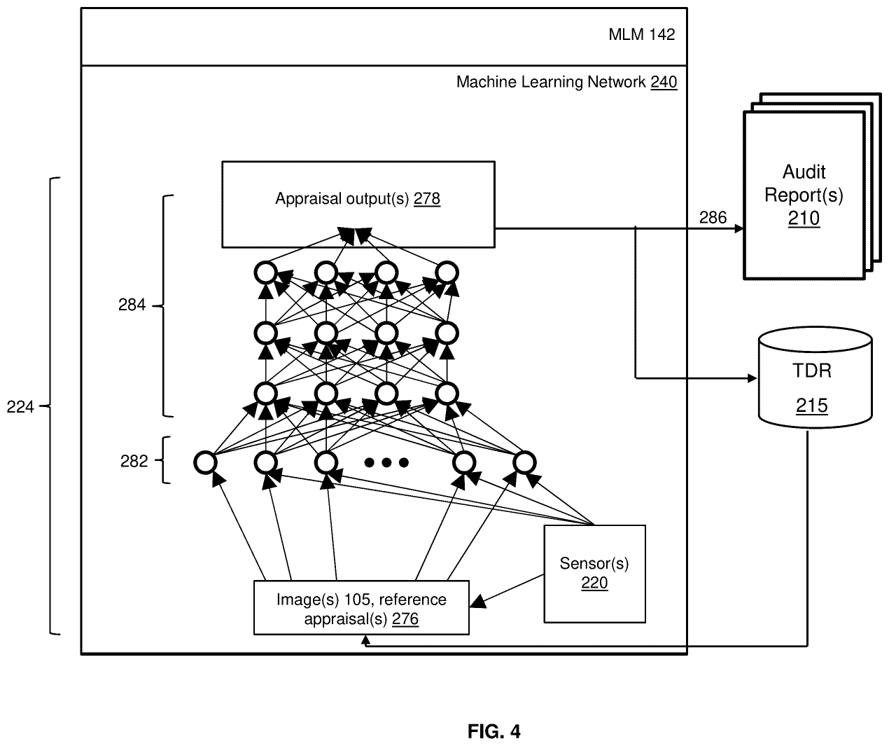

Appraisal program 202, as discussed herein, may be configured to characterize object(s) 104 (including, e.g., determining whether object(s) 104 are authentic, inauthentic, etc.). Via sensor(s) 220 and MLM 142, estimation engine 144 of appraisal program 202 and/or computing device 140 can appraise the value of, characterize, record, etc., various properties of object(s) 104. In some cases, the outcomes of such analysis may be provided via audit report(s) 260 and/or stored on blockchain record 262. Appraisal program 202 can execute or otherwise govern the operation of estimation engine 144 and MLMs 142. Estimation engine 144 may include various modules 222, e.g., one or more software components configured to perform different actions, including without limitation: a calculator, a determinator, a comparator, etc. Similarly, MLM(s) 142 may be executed via appraisal program 202 and/or otherwise may be in communication therewith. Each MLM 142 may have its own modules 224 for implementing various functions, e.g., machine learning operations. Modules 224 may include any of the example subcomponents discussed herein regarding FIGS. 1-4, e.g., MLM 240 (FIG. 4).

Modules 222, 224 can implement various techniques to analyze image(s) 105, object(s) 104 within image(s) 105, and/or appraise object(s) 104 as discussed herein. As shown, computing device 140 may be in communication with sensor(s) 220 (or may be implemented on one or more of sensors 222) and can send and/or receive various forms of data to implement the functions of appraisal program 202. Thus, computing device 140 in some cases may operate as a part of each sensor 220, while in other cases the same computing device 140 may be connected to or included within an intermediate component (e.g., a central or intermediate device) between two or more sensors 220.

Modules 222, 224 of appraisal program 202 can use calculations, look up tables, and similar tools stored in memory 212 for processing, analyzing, and operating on data to perform their respective functions. In general, PU 208 can execute computer program code, such as appraisal program 202 which can be stored in memory 212 and/or storage system 218. While executing computer program code, PU 208 can read and/or write data to or from memory 212, storage system 218, and/or I/O interface 210. Bus 214 can provide a communications link between each of the components in computing device 140. I/O device 216 can include any device that enables a user to interact with computing device 140 or any device that enables computing device 140 to communicate with the equipment described herein and/or other computing devices. I/O device 216 (including but not limited to keyboards, displays, pointing devices, etc.) can be coupled to sensor(s) 220/computing device 140 either directly or through intervening I/O controllers (not shown).

Memory 212 can include a cache of data 300 organized for reference by appraisal program 202. As discussed elsewhere herein, computing device 140 can send, receive, and/or rely various types of data 300, including metadata pertaining to other object(s) 104, image(s) 105, sensor(S) 220, etc. Data 300 thus may be classified into multiple fields and, where desired, sub-fields within each field of data 300. Data 300 may be provided to and/or from sensor 220, e.g., via I/O device 216 and/or other physical or wireless data couplings. To exchange data between multiple sensors 220, computing device 140 may be communicatively connected to other communication features of sensor(s) 220 (I/O interface 210 and/or I/O device 216). In some cases, these communication features may also be contained within memory 212 of computing device 140.

Data 300, as noted, can optionally be organized into a group of fields. In some cases, data 300 may include various fields for cataloguing different types of image(s) 105 after being processed by and/or output from sensor(s) 220. Data 300 also may include reference appraisals 276 (i.e., previously generated and/or other referenced appraisals for other object(s) 104, whether automatic or manually created, used as inputs to appraisal program 202) and/or other data from past instances of implementing methods of the disclosure discussed herein. Data 300 also may be organized into separate fields for appraisal outputs 278 created via MLM 142 and/or estimation engine 144, and/or audit report(s) 260 in which appraisal output(s) 278 are recorded on blockchain record 262 and/or enriched with other cross-referenced information discussed herein. One or more fields of data 300 further may be catalogued within TDR 215 and/or storage system 218. Each type of data 300, however embodied, may be accessible to appraisal program 202 and/or MLM 142, either or each of which in turn may operate as a sub-program within appraisal program 202. Data 300 may be mixed and parsed using appraisal program 202 as it interfaces with a local static database, e.g., via the internet, to store and/or retrieve relevant data from other operating settings, e.g., other environments 100 (FIG. 1) with different teams of sensors 220. Appraisal program 202 thus may output compressed data to a user 102 and/or MLM 142 via the configuration shown in environment 100 (FIG. 1) and/or via other types of connections.

Computing device 140, and/or sensor(s) 220 which include computing device 140 thereon, may comprise any general purpose computing article of manufacture for executing computer program code installed by a user (e.g., a personal computer, server, handheld device, etc.). However, it is understood that computing device 140 is only representative of various possible equivalent computing devices that may perform the various process steps of the disclosure. To this extent, in other embodiments, computing device 140 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 140 may include a program product stored on a computer readable storage device, which can be operative to perform any part of the various operational methodologies discussed herein.

Referring to FIGS. 3 and 4 together, various functions of appraisal program 202 may be implemented via one or more machine learning networks included within and/or otherwise in cooperation with modules 224 of MLM(s) 142. MLMs 142 may include, e.g., any mathematical or algorithmic object capable of estimating an unknown function. A neural network is one example of a component that may be implemented as, or within, modules 224. An example of a machine learning network 240 of module(s) 224 is shown via a schematic diagram to further illustrate processes for generating appraisal output(s) 278, i.e., indications of whether object(s) 104 is/are authentic, a calculated value of object(s) 104, etc., according to the disclosure. Machine learning network(s) within module(s) 224 can relate one or more input variables (e.g., image(s) 105, one or one or more reference appraisals 276 for comparable object(s) 105 and contained within, e.g., a library of training data such as TDR 215) and/or incoming image 105 data from sensor(s) 220. Reference appraisal(s) 274 in some cases, may be produced from past instances of implementing methods described herein and/or with sensor(s) 220 therein.

A layer of inputs 282 includes, e.g., reference appraisal(s) 274, image(s) 105 whether provided via sensor(s) 220 or otherwise obtained, and/or other information transmitted to appraisal program 202 via I/O interface 210 and/or device 216. Inputs 282 can together define multiple nodes. Each node and respective input 282 may be connected to other nodes in a hidden layer 284, which represents a group of mathematical functions. In embodiments of the present disclosure, inputs 282 can include, e.g., initial appraisal(s) 274 for relating various inputs and/or image(s) 105 to possible valuations. Each node of hidden layer 284 can include a corresponding weight representing a factor or other mathematical adjustment for converting input variables into output variables. MLM 142 may additionally or alternatively receive image(s) 105 from sensor(s) 220 for immediate processing as part of the layer of input(s) 282. However, it is understood that other input(s) from sensor(s) 220 and/or reference appraisal(s) 274 also may additionally or alternatively be included in hidden layer 284 in other implementations.

In embodiments of the disclosure, appraisal output 276 can indicate whether object(s) 104 is/are authentic, an appraised value, and/or other relevant valuation features. For instance, appraisal output(s) 276 may include a listing of item(s) 104 cross-referenced with image(s) 105 used for analysis, an appraised value, a listing of techniques and/or reference material(s) used in the appraisal, similar appraisal(s) for comparison, etc. Where desired or applicable, appraisal output 276 can be included within audit report 260 for object(s) 104 under analysis, and/or recorded to blockchain record 262. Appraisal output(s) 276 MLM 142 additionally or alternatively may be stored for future use as reference appraisal(s) 274, e.g., in memory 212, TDR 215, etc.

Module(s) 222 of MLM 142 may include, or take the form of, any conceivable machine learning system, and examples of such systems are described herein. In one scenario, module(s) 222 of MLM 142 may include or take the form of a machine learning network 240, and more specifically can include one or more sub-classifications of machine learning network architectures (e.g., a fully connected neural network, convolutional neural network, recurrent neural network, and/or combinations of these examples and/or other types of artificial neural networks), whether currently known or later developed.

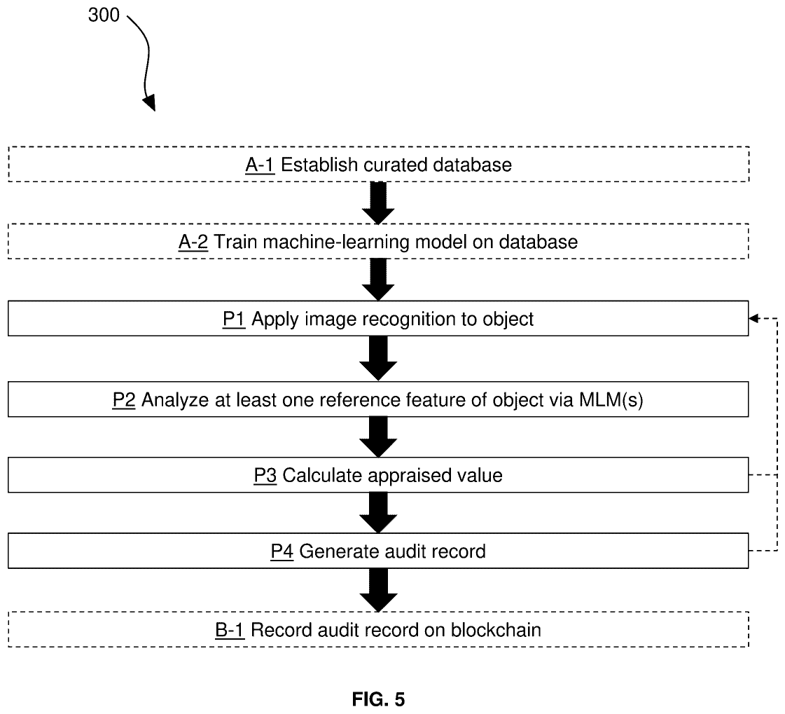

Referring to FIGS. 3-5 together, in which FIG. 5 provides an illustrative flow diagram 300 of methods for appraising object(s) 104 and various optional features, e.g., generating a certifiable audit report 260. The method may include, as preliminary operations and/or a wholly separate operation, processes A-1 and A-2 for preparing the components described herein for appraisal of certain objects 104. Processes A-1 and A-2 are shown in dashed lines to indicate that they may be optional, and/or implemented separately from other processes discussed herein. In process A-1, embodiments of the disclosure may include establishing a curated database (e.g., in memory 212, TDR 215, storage system 218, etc.) including information related to items of art and/or collectibles and their associated appraised value. In some examples, the appraised values are determined by experts 106, and/or by comparison with the values of similar items appraised by expert(s) 106 and/or other actors.

Process A-2 includes training one or more MLMs 142 based on the curated database, e.g., using data stored in TDR 215, to produce an appraisal model capable of determining the value of objects 104 that are similar to objects represented in the training data. At process A-2, the method includes applying the trained image-recognition model(s) to one or more images of an object, the image-recognition model(s) configured to identify reference features (e.g., any identifiable features and/or aspects of the object 104) from image(s) 105. As examples, identifiable features may include colors, shapes, estimated measurements, serial numbers, bar codes, visualized thermal properties of object(s) 104, x-ray scanned features of object(s) 104, electrical properties, etc. MLM(s) 142 need not be retrained on each subsequent object 104 under analysis, i.e., processes A-1, A-2 may not be performed on MLM(s) 142 more than once in some implementations.

In various embodiments, methods of the disclosure can proceed to (or begin with, e.g., in the case of a pre-trained mode) process Pl of applying MLM(s) 142 to image 105. In process P1, sensor(s) 220 may capture image(s) 105, and/or image(s) 105 otherwise may be provided to MLM(s) 142 by any currently known or later developed data transmission solution. Process P1 optionally may also include providing a category of appraisal (e.g., appraisal of substantially two-dimensional artwork, appraisal of collectible objects, etc.) to affect which image recognition tools or techniques will be implemented in MLM(s) 142.

Process P2 includes analyzing at least one reference feature of object 104 via MLM 142 and by reference to the curated database, e.g., as stored in memory 212, TDR 215, etc. Process P2 may include implementing image analysis tools to determine whether one or more colors, feature shapes, estimated sizes, and/or other identifying information (e.g., serial numbers, scannable codes, RFID tags, thermal or electrical properties, etc.) are consistent with known properties of corresponding entry in the curated database. In some implementations of process P2, multiple objects 104 and/or images 105 can be analyzed together with respect to the same curated database. In other implementations, one object 104 can be analyzed via multiple images 105 and/or one image 105 can be analyzed to evaluate reference features of multiple objects 104.

In process P3, modules 222 (e.g., calculating and/or determining components) of estimation engine 144 can calculate the value of object(s) 104 analyzed in process P2. The calculating can include, e.g., simply cross-referencing the indication of whether object(s) 104 is/are authentic to the value of authentic or inauthentic items. In other instances, the calculating in process P3 may include mathematically calculating the value of object(s) 104 based on the condition of an authentic item (e.g., authentic artwork with blemishes, damage, aging effects, etc.). In further implementations, process P3 may include a combination of logical determinations (e.g., whether certain types of blemishes exist and to what extent) and mathematical calculations (e.g., adjusting the value of object(s) 104 based on the logical determinations). In any case, the calculating in process P3 can be in reference to the image analysis details output from process P2. Optionally, the method may continue by returning to process P1 to re-implement processes P1-P3 on a new object 104 and/or image 105.

Process P4 may include generating audit record 260, e.g., for user(s) 102. As discussed herein, audit record 260 may present an identity of object(s) 104 as appraised along with supporting data such as the estimated value of object(s) 104, and (optionally) further information such as a basis for the appraised value (e.g., by displaying the calculations, image analysis tool(s), and/or determinations used), an indication of whether the appraised value is also certified by a standards body, etc. In the case of certification, embodiments of the disclosure optionally may include allowing expert(s) 106 to review appraisal output(s) 278 and, optionally, certify their results in the case where such results are consistent with the assessment of certain expert(s) 106. At this point, the method may return to process PI to re-implement processes P1-P4 and optionally with the inclusion of audit record 260 and/or other outputs as inputs to MLM 142. Optionally, process P5 may include recording audit record 260 on blockchain record 262 (i.e., “recording to blockchain”). As discussed herein, the term “blockchain” distributed ledger refers to a growing list of records (e.g., “blocks”) that are linked together using cryptography on a distributed ledger. Specific blockchain protocols may vary between blockchains. In some blockchains, for example, each block contains a cryptographic hash of the previous block, a timestamp or sequence number, and transaction or other revision, modifications, or updated data. Each block may contain information about previous blocks, forming a chain of blocks such that each additional block reinforces previous blocks to form a modification resistant blockchain. Data in any given block cannot be altered retroactively without altering subsequent blocks. In process P5, the data included in audit report 260 (and generated in process P4) may be encoded on a blockchain as a cryptographic hash. In still further implementations, the data included in audit report 260 upon completing process P5 may be included within a non-fungible token (NFT) inextricably linked to certain object(s) 104 under analysis.

Embodiments of the disclosure provide various technical and commercial advantages, examples of which are discussed herein. By implementing systems and methods of the disclosure, it is possible for various people, organizations, etc. (e.g., groups of experts 106) to analyze and/or authenticate items without necessarily having to be present and/or having to manually survey all aspects of a particular object 104. Moreover, embodiments of the disclosure can improve the quality of appraisals by replacing or supplementing the analysis of a human with machine learning techniques. The disclosure also enables the evaluation of certain object(s) 104 under analysis to be permanently stored in blockchain record 262 to impede or prevent double sales of the same item, sales of inauthentic object(s) 104, etc.

In this document, an “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data storage,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

A “machine learning model” or a “model” refers to a set of algorithmic routines and parameters that can predict an output(s) of a real-world process (e.g., identification or classification of an object) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology. A machine learning model may be trained on a sample dataset (referred to as “training data”).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

It should be understood that various aspects disclosed herein may be combined in different combinations than the combinations specifically presented in the description and accompanying drawings. For example, features, functionality, and components from one embodiment may be combined with another embodiment and vice versa unless the context clearly indicates otherwise. Similarly, features, functionality, and components may be omitted unless the context clearly indicates otherwise. It should also be understood that, depending on the example, certain acts or events of any of the processes or methods described herein may be performed in a different sequence, may be added, merged, or left out altogether (e.g., all described acts or events may not be necessary to carry out the techniques).

The breadth and scope of this disclosure should not be limited by any of the above-described example embodiments but should be defined only in accordance with the following claims and their equivalents.

1. A method comprising:
applying an image recognition model to an image of an object of interest to identify at least one reference feature of the object of interest from the image;
analyzing the at least one reference feature of the object of interest via a machine learning model trained on a curated database of identifiable features, the curated database including a listing of known art or collectibles cross-referenced to appraised values for each known art or collectible in the listing;
calculating an appraised value for the object based on the analyzing; and
generating an audit report for the object of interest, wherein the audit report includes a record of at least one item in the curated database used by the machine learning model to calculate the appraised value.

2. The method of claim 1, further comprising recording the audit report on a digital ledger.

3. The method of claim 2, wherein the digital ledger is a distributed ledger having a plurality of blocks interlinked via cryptographic hashes, and recording the audit report includes adding at least one additional block to the distributed ledger.

4. The method of claim 1, further comprising training a visual large-language model within the machine learning model, based on the curated database.

5. The method of claim 1, further comprising accepting the image of the object from a device including, or communicatively coupled to, the image recognition model.

6. The method of claim 1, wherein the audit report includes an output from the machine learning module indicating a basis of the appraised value.

7. The method of claim 1, wherein the listing of known art or collectibles is further cross-referenced to an indication of whether each appraised value is certified by a standards body.

8. A system comprising:
a processor; and
a memory having programming instructions configured to cause the processor to perform an appraisal by:
applying an image recognition model to an image of an object of interest to identify at least one reference feature of the object of interest from the image;
analyzing the at least one reference feature of the object of interest via a machine learning model trained on a curated database of identifiable features, the curated database including a listing of known art or collectibles cross-referenced to appraised values for each known art or collectible in the listing;
calculating an appraised value for the object based on the analyzing; and
generating an audit report for the object of interest, wherein the audit report includes a record of at least one item in the curated database used by the machine learning model to calculate the appraised value.

9. The system of claim 8, wherein the programming instructions are further configured to cause the processor to record the audit report on a digital ledger.

10. The system of claim 9, wherein the digital ledger is a distributed ledger having a plurality of blocks interlinked via cryptographic hashes, and recording the audit report includes adding at least one additional block to the distributed ledger.

11. The system of claim 8, wherein the programming instructions are further configured to cause the processor to train a visual large-language model within the machine learning model, based on the curated database.

12. The system of claim 8, wherein the programming instructions are further configured to cause the processor to accept the image of the object from a device including, or communicatively coupled to, the image recognition model.

13. The system of claim 8, wherein the audit report includes an output from the machine learning module indicating a basis of the appraised value.

14. The system of claim 8, wherein the listing of known art or collectibles is further cross-referenced to an indication of whether each appraised value is certified by a standards body.

15. A program product comprising a computer readable storage medium with program code for causing a computer system to perform actions including:
applying an image recognition model to an image of an object of interest to identify at least one reference feature of the object of interest from the image;
analyzing the at least one reference feature of the object of interest via a machine learning model trained on a curated database of identifiable features, the curated database including a listing of known art or collectibles cross-referenced to appraised values for each known art or collectible in the listing;
calculating an appraised value for the object based on the analyzing; and
generating an audit report for the object of interest, wherein the audit report includes a record of at least one item in the curated database.

16. The program product of claim 15, further comprising program code for recording the audit report on a digital ledger.

17. The program product of claim 16, wherein the digital ledger is a distributed ledger having a plurality of blocks interlinked via cryptographic hashes, and recording the audit report includes adding at least one additional block to the distributed ledger.

18. The program product of claim 15, further comprising program code for training a visual large-language model within the machine learning model, based on the curated database.

19. The program product of claim 15, further comprising program code for accepting the image of the object from a device including, or communicatively coupled to, the image recognition model.

20. The program product of claim 15, wherein the audit report includes an output from the machine learning module indicating a basis of the appraised value.
